(19) United States
(12) Patent Application Publication
(10) Pub. No.: US 2021/0067976 A1
(43) Pub. Date: Mar. 4, 2021

(54) SIGNALING TO AVOID IN-CHANNEL AND ADJACENT CHANNEL INTERFERENCE

(71) Applicants: Laurent Cariou, Portland, CA (US); Bahareh Sadeghi, Portland, OR (US); Thomas J. Kenney, Portland, OR (US)

(72) Inventors: Laurent Cariou, Portland, CA (US); Bahareh Sadeghi, Portland, OR (US); Thomas J. Kenney, Portland, OR (US)

(21) Appl. No.: 17/096,853

(22) Filed: Nov. 12, 2020

Related U.S. Application Data
(60) Provisional application No. 62/934,096, filed on Nov. 12, 2019.

(51) Int. Cl. H04W 16/14; H04W 74/08; H04W 72/08; H04W 24/10; H04W 84/12

(52) U.S. Cl. CPC H04W 16/14; H04W 74/0808; H04W 84/12; H04W 24/10; H04W 72/082

(57) ABSTRACT

This disclosure describes systems, methods, and devices related to in-channel and adjacent channel interference avoidance. The device may perform a clear channel assessment (CCA) measurement on a portion of a second operating channel, wherein the portion shares a contiguous edge with a first operating channel that is adjacent to the second operating channel. The device may detect an energy on the portion of the second operating channel based on the CCA measurement. The device may compare the detected energy to an energy detection (ED) threshold. The device may determine to communicate on the second operating channel based on the comparison of the energy to the ED threshold.

### CROSS-REFERENCE TO RELATED APPLICATION(S)

This application is related to and claims priority to U.S. Provisional Patent Application No. 62/934,096, filed Nov. 12, 2019, which is incorporated herein by reference in its entirety.

### TECHNICAL FIELD

This disclosure generally relates to systems and methods for wireless communications and, more particularly, to in-channel and adjacent channel interference avoidance.

### BACKGROUND

Wireless devices are becoming widely prevalent and are increasingly requesting access to wireless channels. The Institute of Electrical and Electronics Engineers (IEEE) is developing one or more standards that utilize Orthogonal Frequency-Division Multiple Access (OFDMA) in channel allocation.

### BRIEF DESCRIPTION OF THE DRAWINGS

FIG. 1 is a network diagram illustrating an example network environment for in-channel and adjacent channel interference avoidance, in accordance with one or more example embodiments of the present disclosure.

FIG. 2 depicts a block diagram of an example dedicated short-range communication (DSRC) frequency allocation according to one or more embodiments of the present disclosure.

FIG. 3 depicts an illustrative schematic diagram of in-channel and adjacent channel interference, in accordance with one or more example embodiments of the present disclosure.

FIG. 4 depicts an illustrative schematic diagram for in-channel and adjacent channel interference avoidance in accordance with one or more example embodiments of the present disclosure.

FIG. 5 depicts an illustrative schematic diagram for an example information element for in-channel and adjacent channel interference avoidance in accordance with one or more example embodiments of the present disclosure.

FIG. 6A depicts another illustrative schematic diagram for an example information element for in-channel and adjacent channel interference avoidance in accordance with one or more example embodiments of the present disclosure.

FIG. 6B illustrates a mapping between the bitmap and the measured values in accordance with one or more embodiments.

FIG. 7 illustrates a flow diagram of an illustrative process for an illustrative in-channel and adjacent channel interference avoidance system, in accordance with one or more example embodiments of the present disclosure.

FIG. 8 illustrates a functional diagram of an exemplary communication station that may be suitable for use as a user device, in accordance with one or more example embodiments of the present disclosure.

FIG. 9 illustrates a block diagram of an example machine upon which any of one or more techniques (e.g., methods) may be performed, in accordance with one or more example embodiments of the present disclosure.

FIG. 10 is a block diagram of a radio architecture in accordance with some examples.

FIG. 11 illustrates an example front-end module circuitry for use in the radio architecture of FIG. 10, in accordance with one or more example embodiments of the present disclosure.

FIG. 12 illustrates an example radio IC circuitry for use in the radio architecture of FIG. 10, in accordance with one or more example embodiments of the present disclosure.

FIG. 13 illustrates an example baseband processing circuitry for use in the radio architecture of FIG. 10, in accordance with one or more example embodiments of the present disclosure.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

A new 802.11ngv air interface may be defined that is understood by legacy 80.211p (“11p) STAs (forward-compatible) but still provides improvements, especially with regards to range: legacy compatible 802.11ngv (“11ngv) protocol data unit (PPDU) format (also referred to as next generation vehicle (NGV) Control PHY), and may define another 802.11ngv air interface that is not understood by legacy 11p STAs: legacy non-compatible 11ngv PPDU format (also referred to as NGV Enhanced PHY). The new 802.11nvg air interface is increasingly applicable in vehicle to vehicle (V2V) and vehicle-to-everything (V2X) communication.

With the increased focus on enabling smart and increasingly autonomous vehicles, V2X has become one of the main target use cases to support over next generation wireless communication technologies, such as 5G. V2X communication is the passing of information from a vehicle to any entity that may affect the vehicle, and vice versa. It is a vehicular communication system that incorporates other more specific types of communication as V2I (Vehicle-to-Infrastructure), V2N (Vehicle-to-network), V2V (Vehicle-to-vehicle), V2P (Vehicle-to-Pedestrian), V2D (Vehicle-to-device) and V2G (Vehicle-to-grid).

The dedicated short-range communication (DSRC) band of 5.9 GHz (e.g., 5.85-5.925 GHz) is reserved for vehicular communications, that is, V2X (V2I/V2N/V2V/V2P) communications. The 802.1ip standard defined as the air interface and WAVE protocols have been specified on top of 802.11p to enable different vehicular services. 802.11p PHY is the 802.11j PHY, i.e., 802.11a PHY (20 MHz, SISO) downclocked by 2 in order to operate in 10 MHz DSRC channels. The 802.11p MAC protocol defines transmission out of the context of BSS (OCB), which enables the vehicles to broadcast safety messages without association. The format of these safety messages and their content are defined in IEEE 1609 and SAE specifications, respectively.

In IEEE 1609, multi-channel operation is also defined; to ensure all cars receive high priority safety-related messages. There also exists a dedicated control channel (CCH) designated for this purpose. These messages follow the WAVE Short Message Protocol (WSMP). Additionally, information about other services on other channels is transmitted using the CCH. To enhance the V2X services, as well as to be competitive with cellular based V2X solutions, improvements have been made to the currently deployed 802.1ip air interface to provide higher throughput (using e.g., MIMO, higher MCSs), to increase reliability (using e.g., low-density parity check (LDPC) coding), and to provide longer range and robustness to high mobility (using, for example, extended range (DCM), space time block coding (STBC), midambles, traveling pilots, etc.), among other potential enhancements.

Currently, 11p/DSRC is deployed with a channel bandwidth of 10 MHz. The 11p standard defines a 10 MHz air interface, which is the 11a air interface down-clocked by 2. It is possible to directly use the 11a air interface on the 20 MHz channels 175 and 181, but this is currently not done because of coexistence issues on the overlapping 10 MHz channels (174, 176) and (180, 182), respectively.

For NGV, a definition of channel bonding over as many channels as possible (contiguous or not) is now desired. Before transmitting, every station device (STA) is required to perform clear channel assessment (CCA). CCA is comprised of both PD (packet detection) and ED (energy detection). The CCA PD threshold is defined to be −85 dBm for a 10 MHz channel. PD consists of detecting a Wi-Fi physical layer PPDU start of packet on a 10 MHz channel. This is typically done by correlating with the known short training field (STF) field, which is the first field on the Wi-Fi PPDU (although other portions of the preamble/signal may also be used).

The CCA ED threshold is −65 dBm for a 10 MHz channel. CCA ED is a measurement of the energy on the entire 10 MHz during some observation period and checks whether the energy is above or below a threshold.

As it is simply measuring energy, CCA ED will detect any signals. For example, it may detect a non-Wi-Fi signal or Wi-Fi PPDUs for which the start of packet STF has been missed on that 10 MHz channel. For example, it may detect energy that is relatively equal over the 10 MHz band.

In other aspects, CCA ED may also detect out-of-band emission (leakage) from adjacent 10 MHz channels. For example, the energy here decreases in the frequency domain, with the largest power at the edge of the channel, which is adjacent to the interfering signal, and then decreases over the 10 MHz bandwidth. If the energy averaged over the 10 MHz is above the CCA threshold, the CCA is busy. Otherwise, the CCA is not busy.

One design goal of NGV is to improve the reliability of transmissions. At the same time, it will enable operation with 10 MHz on all channels, and even operation with 20 MHz over multiple bonded adjacent channels. These transmissions are mostly broadcasted, and therefore quite sensitive to in-channel collisions and failed receptions. With respect to in-channel collisions, two transmissions may occur at the same time on the same channel (from hidden STAs for instance), and may be received from STAs with a range of power levels such that either neither of the transmissions are successfully received or only one of them is successfully received.

One example of this circumstance could include a vehicle operating near two other connected vehicles, where one of the connected vehicles operates opposite the other with respect to the receiving STA associated with the vehicle in the middle. In this situation, there may exist a hidden node with respect to one or more of the communicating STAs. The two outer-most STAs (e.g., STA1 and STA2) may communicate within operational range with the center STA (STA3), but be otherwise unaware of the other's communication due to distance from one another, or due to signal obstruction. If neither of STAs 1 or STA2 are aware of the other's transmission time or periodicity, in-channel collision may occur and the signal may not be receivable by any listening STAs. This circumstance could result in signal loss for all receiving STA (e.g., the center vehicle of the three vehicles).

Another example of signal loss may include failed signal reception due to adjacent channel interference (also referred to as channelization). Given two vehicles or other STAs operating proximate to one another, if a first station (STA 1) is very close to a second station (STA2), and STA2 operates on an adjacent channel to STA1, when STA1 transmits, it is possible that the interference generated by STA1's transmission, the STA2 receiver may not successfully receive PPDUs that are sent on STA2's channel.

Example embodiments of the present disclosure relate to systems, methods, and devices for signaling to avoid in-channel and adjacent channel interference.

To address all the issues identified previously, embodiments of the present disclosure are directed to improve system performance. Aspects of the present disclosure may enable larger use of the wireless communication spectrum along with wider channel use for the NGV system. An in-channel and adjacent channel interference avoidance system may enhance the current energy detection mechanisms and reduce the granularity of the measurements.

In one or more embodiments, an in-channel and adjacent channel interference avoidance system may reduce the 10 MHz and 20 MHz energy detection (ED) threshold. Some aspects of the present disclosure may also reduce packet detect (PD) threshold. In-channel and adjacent channel interference avoidance may increase the chances that a transmission will be deferred if another transmission is detected, which means that the medium is already busy. This may improve performance in the cases of hidden nodes.

In one or more embodiments, the in-channel and adjacent channel interference avoidance system may define a new CCA rule for respectively smaller bandwidths (e.g., 2 MHz, 4 MHz, 5 MHz, etc.) within the operating channel of 10 MHz or 20 MHz channels. In one aspect, if a STA is operating at 10 MHz, instead of measuring CCA only on 10 MHz (“CCA_10 MHz”), that STA may now measure CCA_10 MHz by looking at energy received on the entire 10 MHz.

According to another embodiment, the in-channel and adjacent channel interference avoidance system may measure CCA (e.g., CCA_2 MHz or CCA_4 MHz) on the different 2 or 4 MHz segments within the 10 MHz channel. For example, CCA measurement segments may include a minimum of 2 or 4 MHz CCA segments, which may be measured at each band edge of the 10 MHz channel.

According to one embodiment, if one of the CCA_2 MHz measurements is higher than the ED-edge threshold (for example, the 10 MHz ED threshold adjusted for a 2/4/5 MHz bandwidth), then CCA would then indicate that the channel is busy.

In the present example embodiment, it is advantageous to measure the 2/4/5 MHz segment on each edge of the 10 MHz or 20 MHz channel. Accordingly, the in-channel and adjacent channel interference avoidance system may detect an adjacent channel interference (ACI) and defer transmission more often when ACI is detected. In an example embodiment, the system may be configured such that STA1 transmits to STA2 on Channel 174, and STA 3 transmits to STA 4 on Channel 175. This may decrease the chances that any ACI incurred by activity on channel 175 (STA 3 to 4) would cause the transmission on channel 174 to fail (STA1 to STA2). Conversely, this approach also reduces the chances that STA1's transmission would cause the transmission of STA 3 to STA 4 (on the adjacent channel) to fail.

Since embodiments of the present disclosure reduce the chances of accessing the medium by a device, it may lead to a reduction in the overall capacity offered over all channels. The impact is likely minimal for low or medium load environments, but it may be an issue for high load. For that reason, an in-channel and adjacent channel interference avoidance system may facilitate that such new ED levels, or the use of the new CCA levels is governed by the upper layers.

According to one embodiment, the in-channel and adjacent channel interference avoidance system (hereafter interference avoidance system) may cause the STA to measure and analyze the CCA over a period of time, and generate a report of recurrent interference to a higher layer. Responsively, the higher layer, which is responsible for scheduling future transmissions, may adapt any transmission schedule in order to avoid periods where the channel will likely be busy.

According to an embodiment, the interference avoidance system may cause a Wi-Fi device to measure CCA levels over a period of time, and store that information in memory. If the Wi-Fi device detects periodic 11p transmissions (signals that it has successfully received), the interference avoidance system may cause the device to store the address of the transmitter and the periodicity (start time/end time).

According to another embodiment, if the interference avoidance system detects periodic interference from adjacent channels (ACI), the interference avoidance system may cause the to store CCA level (on the 10 MHz CCA or on an edge of the 10 MHz CCA), and store periodicity information that may include a start time and an end time. In one aspect, the interference avoidance system may cause the device to store CCA level in increments of 2 MHz or 4 MHz. Other increments are possible, and such embodiments are contemplated.

According to another embodiment, the interference avoidance system may cause to simplify information during periods where the CCA is busy and periods where CCA is idle.

According to an embodiment, the interference avoidance system may cause to forward detected ACI information to higher layers, such that the system optimizes the transmission time of a Wi-Fi device (PHY/MAC) to send a packet in a specific channel. This may include, for example, defining transmission target time to not overlap with the Service Periods (SPs) during which there is interference, or collisions with other Wi-Fi signals in channel (or group of channels). This may further include causing to perform spectral management in the immediate area/time and frequency. Performing spectral management may include, for example, channel control that can include moving devices, or informing the devices that the channel has issues associated with a particular frequency or band of frequencies.

According to another embodiment, the interference avoidance system may cause to select the primary 10 MHz channel within a 20 MHz channel.

In another embodiment, the in-channel and adjacent channel interference avoidance system may cause to broadcast information of periodic interference over the air to other STAs. The system may include this information in a Broadcast Ack frame, a new ACI announcement frame, or another frame. In one aspect, if the frame reports an interference from a signal that was detected, it can include a set (or a subset) of parameters including, for example, the address from which the STA received the PPDU, and/or from which the STA received power and when that power was received. This information may include, for example, a start time, an end time and/or a periodicity.

In other aspects, the frame may further include a timestamp such that STAs receiving the frame not synchronized with the STA transmitting the frame, is able to determine when the interference occurred based on that STA's time reference.

According to an embodiment, if the frame reports an ACI or an interference received in-band from a non-Wi-Fi signal, it can provide a CCA-ED level of interference (received signal strength), a start time, an end time, and/or a periodicity. The interference avoidance system may cause to send this new information frame in the operating channel of the STA in a periodic manner, or cause to send the information in another channel (either the adjacent channel or the control channel).

In one embodiment where the interference avoidance system causes to send the new information frame in either the adjacent channel or the control channel, the frame may further include, for each interference reported, the channel on which this interference is reported.

According to an embodiment, the interference avoidance system may also cause to send payload information in the payload generated by the upper layers, if the control is to be handled above Wi-Fi MAC. Using this information, neighboring STAs can ensure that upcoming transmissions will not be scheduled to overlap with such periodic interference, which may increase the chances of successful reception from all the STAs in range.

The elements of the one or more embodiments of this disclosure may reduce the chances for overlapping transmissions, therefore reducing interference.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

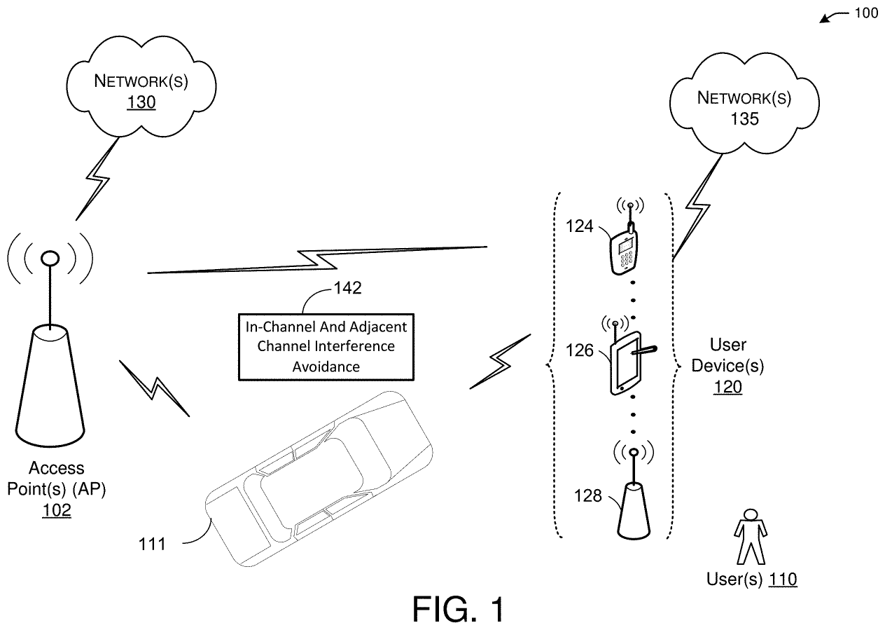

FIG. 1 is a network diagram illustrating an example network environment of in-channel and adjacent channel interference avoidance, according to some example embodiments of the present disclosure. Wireless network 100 may include one or more user devices 120 and one or more access points(s) (AP) 102, which may communicate in accordance with IEEE 802.11 communication standards. The user device(s) 120 may be mobile devices that are non-stationary (e.g., not having fixed locations) or may be stationary devices.

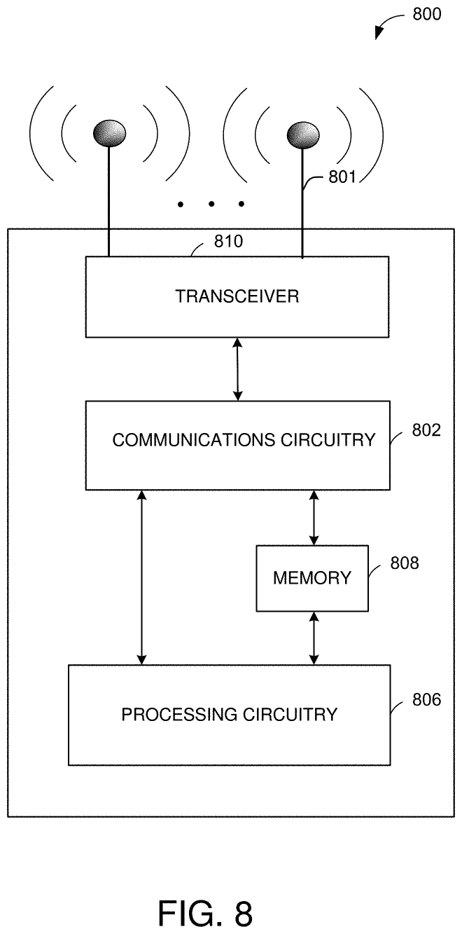

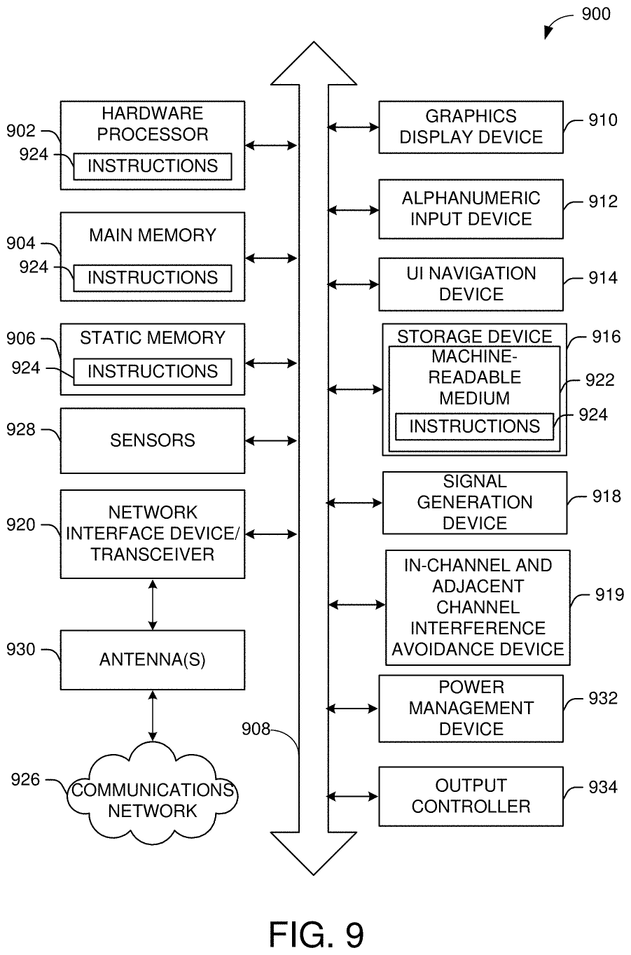

In some embodiments, the user devices 120 and the AP 102 may include one or more computer systems similar to that of the functional diagram of FIG. 8 and/or the example machine/system of FIG. 9.

One or more illustrative user device(s) 120 and/or AP(s) 102 may be operable by one or more user(s) 110. It should be noted that any addressable unit may be a station (STA). An STA may take on multiple distinct characteristics, each of which shape its function. For example, a single addressable unit might simultaneously be a portable STA, a quality-of-service (QoS) STA, a dependent STA, and a hidden STA. The one or more illustrative user device(s) 120 and the AP(s) 102 may be STAs. The one or more illustrative user device(s) 120 and/or AP(s) 102 may operate as a personal basic service set (PBSS) control point/access point (PCP/AP). The user device(s) 120 (e.g., 124, 126, or 128) and/or AP(s) 102 may include any suitable processor-driven device including, but not limited to, a mobile device or a non-mobile, e.g., a static device. For example, user device(s) 120 and/or AP(s) 102 may include, a user equipment (UE), a station (STA), an access point (AP), a software enabled AP (SoftAP), a personal computer (PC), a wearable wireless device (e.g., bracelet, watch, glasses, ring, etc.), a desktop computer, a mobile computer, a laptop computer, an Ultrabook™ computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. Other devices, including smart devices such as lamps, climate control, car components, household components, appliances, etc. may also be included in this list.

As used herein, the term “Internet of Things (IoT) device” is used to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

The user device(s) 120 and/or AP(s) 102 may also include mesh stations in, for example, a mesh network, in accordance with one or more IEEE 802.11 standards and/or 3GPP standards.

Any of the user device(s) 120 (e.g., user devices 124, 126, 128), and AP(s) 102 may be configured to communicate with each other via one or more communications networks 130 and/or 135 wirelessly or wired. The user device(s) 120 may also communicate peer-to-peer or directly with each other with or without the AP(s) 102. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 120 (e.g., user devices 124, 126, 128) and AP(s) 102 may include one or more communications antennas. The one or more communications antennas may be any suitable type of antennas corresponding to the communications protocols used by the user device(s) 120 (e.g., user devices 124, 126 and 128), and AP(s) 102. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the user devices 120 and/or AP(s) 102.

Any of the user device(s) 120 (e.g., user devices 124, 126, 128), and AP(s) 102 may be configured to perform directional transmission and/or directional reception in conjunction with wirelessly communicating in a wireless network. Any of the user device(s) 120 (e.g., user devices 124, 126, 128), and AP(s) 102 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the user device(s) 120 (e.g., user devices 124, 126, 128), and AP(s) 102 may be configured to perform any given directional transmission towards one or more defined transmit sectors. Any of the user device(s) 120 (e.g., user devices 124, 126, 128), and AP(s) 102 may be configured to perform any given directional reception from one or more defined receive sectors.

MIMO beamforming in a wireless network may be accomplished using RF beamforming and/or digital beamforming. In some embodiments, in performing a given MIMO transmission, user devices 120 and/or AP(s) 102 may be configured to use all or a subset of its one or more communications antennas to perform MIMO beamforming.

Any of the user devices 120 (e.g., user devices 124, 126, 128), and AP(s) 102 may include any suitable radio and/or transceiver for transmitting and/or receiving radio frequency (RF) signals in the bandwidth and/or channels corresponding to the communications protocols utilized by any of the user device(s) 120 and AP(s) 102 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g. 802.11b, 802.11g, 802.11n, 802.11ax), 5 GHz channels (e.g. 802.11n, 802.11ac, 802.11ax), or 60 GHz channels (e.g. 802.11ad, 802.11ay). 800 MHz channels (e.g. 802.11ah). The communications antennas may operate at 28 GHz and 40 GHz. It should be understood that this list of communication channels in accordance with certain 802.11 standards is only a partial list and that other 802.11 standards may be used (e.g., Next Generation Wi-Fi, or other standards). In some embodiments, non-Wi-Fi protocols may be used for communications between devices, such as Bluetooth, DSRC, Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

In one embodiment, and with reference to FIG. 1, one or more APs 102, or more user devices 120 and/or vehicles 111 may communicate with each other through an enhanced 802.11ngv air interface.

It is understood that the above descriptions are for purposes of illustration and are not meant to be limiting.

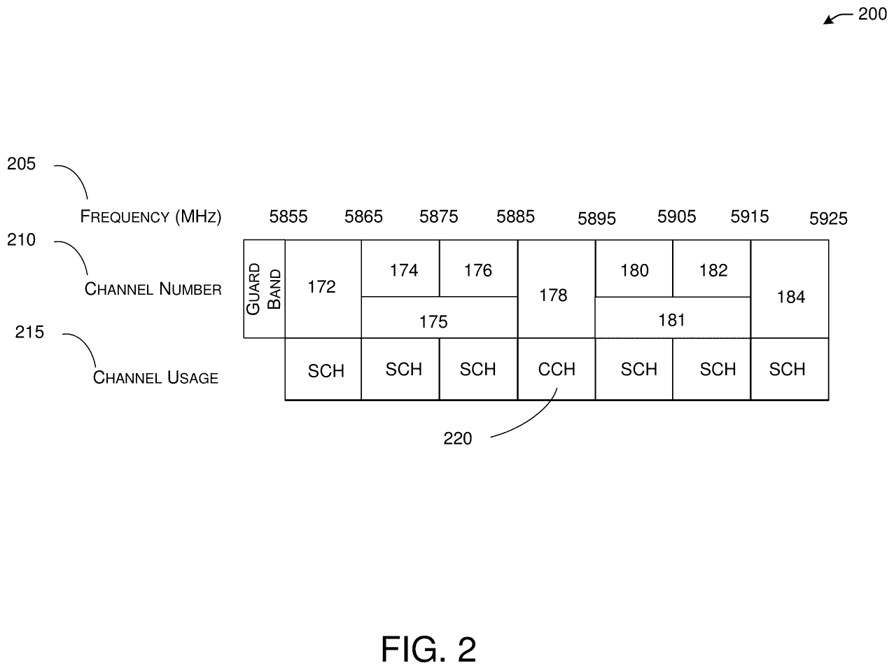

FIG. 2 depicts a block diagram of an example DSRC frequency allocation 200, according to one or more embodiments of the present disclosure.

Referring now to FIG. 2, a block diagram of an example DSRC frequency allocation 200 is depicted, according to one or more embodiments of the present disclosure. With the increased focus on enabling smart and increasingly autonomous vehicles, as introduced above, V2X has become a widely-supported technology for next generation wireless communication technologies, such as 5G. V2X communication is the passing of information from a vehicle to any entity that may affect the vehicle, and vice versa. It is a vehicular communication system that incorporates other more specific types of communication as V2I, V2N, V2V, V2P, V2D, and V2G.

The DSRC frequency allocation 200 illustrates a DSRC frequency band 205, which includes frequencies 5.85-5.925 GHz. Channel numbers 210 are shown respectively associated with 10 MHz frequency channel bands. The DSRC band allocation 200 is reserved for vehicular communications including, for example, V2X (V2I/V2N/V2V/V2P) communications. In one or more embodiments, the in-channel and adjacent channel interference avoidance system 142 may facilitate avoidance of in-channel and adjacent channel interference. The 802.11p standard is defined as the air interface and WAVE protocols have been specified on top of 802.11p to enable different vehicular services.

The dedicated short-range communication (DSRC) band of 5.9 GHz (e.g., 5.85-5.925 GHz) is reserved for vehicular communications, that is, V2X (V2I/V2N/V2V/V2P) communications. The 802.11p standard defined as the air interface and WAVE protocols have been specified on top of 802.11p to enable different vehicular services. 802.11p PHY is the 802.11j PHY, i.e., 802.11a PHY (20 MHz, SISO) downclocked by 2 in order to operate in 10 MHz DSRC channels. The 802.11p MAC protocol defines transmission out of context of BSS (OCB), which enables the vehicles to broadcast safety messages without association. The format of these safety messages and their content are defined in IEEE 1609 and SAE specifications, respectively.

In IEEE 1609, multi-channel operation is also defined, as shown by channel numbers 210, to ensure all cars receive high priority safety related messages. FIG. 2 depicts a plurality of channel usage information 215, that can include scheduling and channel control. For example, a dedicated control channel (CCH) 220 may be designated to communicate V2X safety messages, which may avoid vehicle collisions and enhance V2X communication ranges. These messages follow the WAVE Short Message Protocol (WSMP). Additionally, information about other services on other channels is transmitted using the CCH 220. To enhance the V2X services, improvements have been made to the currently deployed 802.11p air interface to provide higher throughput (using e.g., MIMO, higher MCSs), to increase reliability (using e.g., low-density parity check (LDPC) coding), and to provide longer range and robustness to high mobility (using, for example, extended range (DCM), space time block coding (STBC), midambles, traveling pilots, etc.), among other potential enhancements.

Currently 11p/DSRC is deployed with a channel bandwidth of 10 MHz. The 11p standard defines a 10 MHz air interface, which is the 11a air interface down-clocked by 2. It is possible to directly use the 11a air interface on the 20 MHz channels 175 and 181, but this is currently not done because of coexistence issues on the overlapping 10 MHz channels (174, 176) and (180, 182), respectively.

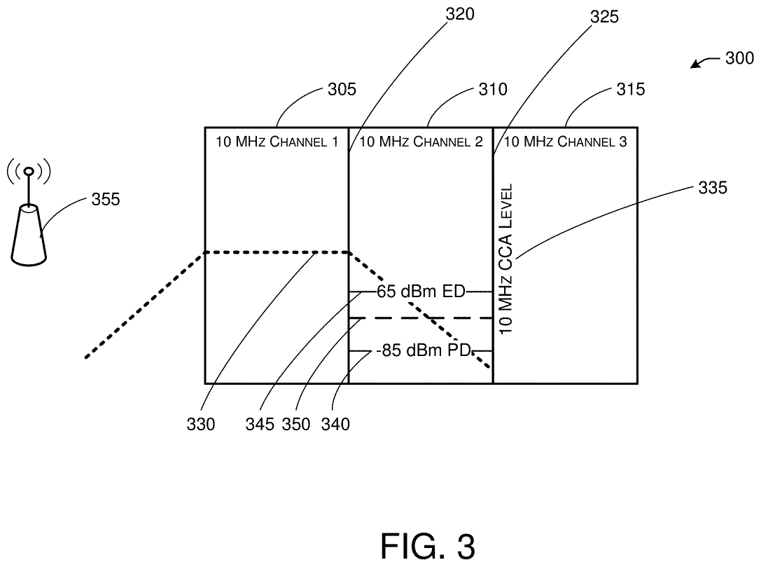

FIG. 3 depicts an illustrative schematic diagram 300 of in-channel and adjacent channel interference, in accordance with one or more example embodiments of the present disclosure. The diagram 300 illustrates a plurality of adjacent channels including a first 10 MHz channel (Channel 1) 305, a second 10 MHz channel (Channel 2) 310 disposed adjacent to channel 1305, and a third 10 MHz channel (Channel 3) 315 disposed adjacent to the second channel 310. The first channel 305 shares an edge 320 with the second channel 310, and the second channel 310 shares a second edge 325 with the third channel 315.

For NGV, a definition of channel bonding over as many channels as possible (contiguous or not) is now desired. Before transmitting a signal transmission 330, every station device (STA) is required to perform CCA (clear channel assessment) which may be quantified as a 10 MHz CCA level 335. CCA is comprised of both PD (packet detection) 340 and ED (energy detection). As illustrated in FIG. 3, the CCA PD 340 threshold is defined to be −85 dBm for a 10 MHz channel. Other thresholds are contemplated, and may be possible according to various embodiments. PD consists of detecting a Wi-Fi physical layer PPDU start of packet on a 10 MHz channel (e.g., the channel 2 310). This is typically done by correlating with a known short training field (STF) field, which is the first field on the Wi-Fi PPDU (although other portions of the preamble/signal may also be used).

FIG. 3 illustrates one example of interference incurred in one 10 MHz band associated with the Channel 2 310 when an adjacent channel transmission 330 occurs on Channel 1305. It should be appreciated that interference shown in FIG. 3 may occur on any channel where a contiguous channel is transmitting a data transmission, such as the third channel 315, etc. It is advantageous to avoid data collisions associated with adjacent channel interference (ACI), and even interference occurring on a channel itself (also called channelization) due to periodic channel traffic from multiple STAs attempting to broadcast periodic traffic, where some of the periodic traffic interferes with one another.

With respect to ACI, the PD 340 and ED 345 is determined by measuring the CCA level 335 on the channel of interest (which is, in the present example, the second channel 310) when a STA transmits on the adjacent channel 1305. Here, the energy associated with the signal transmission 330 is measured and averaged over the entire 10 MHz channel (the average being illustrated as an energy level line 350) is lower than the ED level 345. This means that the CCA would register as idle. Since the second channel 310 appears to be idle, the STA 355 (or another STA not shown in FIG. 3) will then transmit on the second channel 310, while there are chances that ACI between the 2 links will cause some of the transmissions to fail. In the context of V2X signal transmission, such data collisions are problematic because vehicle safety, among other concerns, requires a high level of signal continuity and reliability.

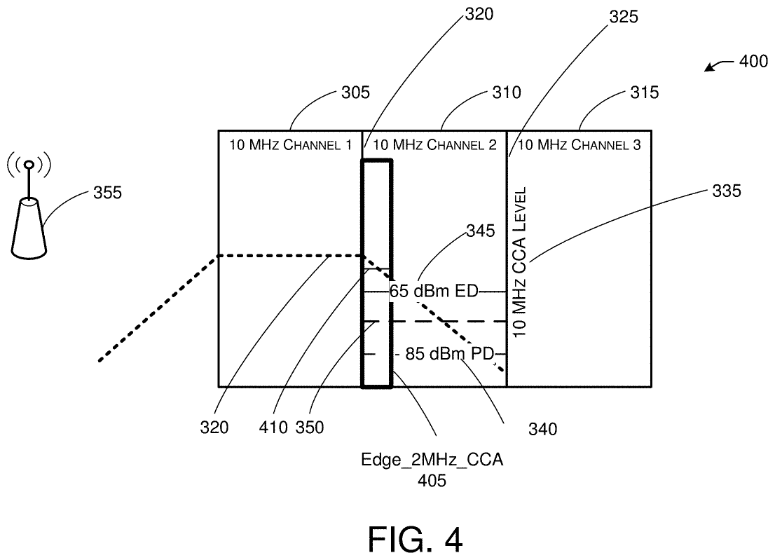

FIG. 4 depicts an illustrative schematic diagram 400 for in-channel and adjacent channel interference avoidance, in accordance with one or more example embodiments of the present disclosure. The schematic diagram 400 illustrates the measurement of the CCA levels 335 on the second channel 310 when the STA 355 transmits on the adjacent channel 1 305. ACI, as was illustrated in FIG. 3, is again coming from the adjacent channel 305. Normally there are increased rejection and filtering for ACI interference, as illustrated by the decreasing signal strength of the signal 330 from the first edge 320 to the second edge 325. As explained in FIG. 3, another receiving STA (not shown in FIG. 4) may not sense a signal from another vehicle, where the signal is right next to the channel currently being used (on an adjacent channel). For example, when judging whether the channel 310 is idle or busy based alone on the average PD 340, the signal 330 may appear as channel noise on the current channel 2 310 when the signal is sent on the adjacent channel. All vehicles are listening to all channels within the spectrum, a situation may occur where a signal is broadcast but it is not received because it is interpreted as signal noise or interference.

Instead of lowering the ED threshold, the present embodiments describe a technique where the system takes advantage of the slope of detected energy from adjacent channels. The CCA function measures energy of 2 MHz bands across the 10 MHz channel band during transmission on the adjacent channel. When CCA is measured above corresponding ED levels associated with a predetermined threshold, (e.g., −65 dBm), the system will determine that CCA is busy.

According to an embodiment, the adjacent channel interference avoidance system 142 may cause to change a sensitivity threshold in which the signal 330 is detected. Instead of raising the ED threshold to be more sensitive, the channel interference avoidance system 142 may cause to split the 10 MHz into a plurality of frequency sub-bands (e.g., a 2 MHz sub-band 405), and determine whether energy is met for every 2 MHz segment.

The embodiment described in FIG. 4 illustrates a technique where the channel interference avoidance system 142 takes advantage of the slope of detected energy associated with the adjacent channel transmission 330 from the adjacent channel 305 instead of lowering the ED threshold 345. Accordingly, the CCA function causes to measure the energy of one or more 2 MHz bands (e.g., the edge_2 MHz_CCA 405) across the 10 MHz channel band 310 during transmission on the adjacent channel 305. When CCA is measured above corresponding ED levels associated with a predetermined threshold, (e.g., −65 dBm), the system may then determine that CCA is busy.

As shown by the averaged energy level 350, the energy measured and averaged over the entire 10 MHz channel is lower than the ED level 345, which again makes the CCA appear as idle as in FIG. 3. According to an embodiment, the channel interference avoidance system may cause to split the 10 MHz to a second CCA of 2 MHz (edge_2 MHz_CCA). Now, the energy measured and averaged 410 over the 2 MHz CCA 405 on the edge 320 of channel 2 310 is higher than the proportional 2 MHz ED level, which makes the edge_2 MHz_CCA 405 appear as busy. The STA 355 (or another STA not shown in FIG. 4) will then not transmit on the second channel 310, avoiding the chance of ACI between the 2 links will cause some of the transmissions to fail, including the signal 330.

According to another embodiment, the adjacent channel interference avoidance system 142 may further cause to change sensitivity on a second edge 325, whereby any ACI originating from the adjacent channel 3 315 may be avoided.

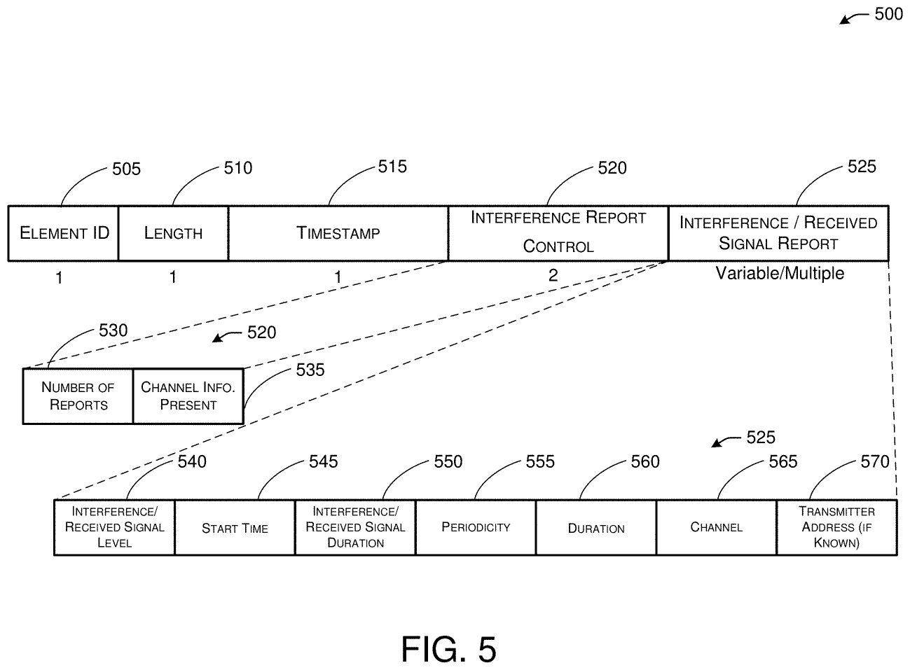

FIG. 5 depicts an illustrative schematic diagram for an example information element for in-channel and adjacent channel interference avoidance in accordance with one or more example embodiments of the present disclosure. Every station, especially in the context of V2X communication, is listening to the channels described with respect to FIGS. 2-4. Every periodic point, (e.g., 100 ms or so) the station 355 (as shown in FIGS. 3 and 4) may send a signal updating other vehicles as to that STA's location. In some instances, it may happen that two stations send the periodic signal at the same time. A periodic spike may indicate a communication that may interfere with a signal, which may be received from a neighboring STA. The periodic spike may interfere with other signals received at the STA, and moreover, the periodic spike may be channel traffic with which any collisions would interfere should a station send a signal at the same time as the periodic spike. When two signals are sent at the same time, the probability increases that one or both of the signals may interfere and not be received by other recipients. Accordingly, it is advantageous to monitor and record periodicity of what is observed over the air, including information associated with the packets received from other STAs, store the periodic pattern information, packet information and other data, and cause to report such information to other listening devices so that can adjust for periodicity and/or cause to perform other coordinating actions.

According to an embodiment, if the adjacent channel interference avoidance system 142 causes to observe a relatively large spike of energy (e.g., a spike of energy that is likely to be determined to be greater than signal noise) in the channel traffic at a predetermined granularity of observation (e.g., every 100 ms), the channel interference avoidance system 142 may cause to determine to not send a competing signal at the expected periodic energy spike. This observation and periodicity adjustment may avoid signal crashes associated with periodic data conflicts on the STA by observing the conflict, and by broadcasting that information to other nearby STAs.

According to an embodiment, the adjacent channel interference avoidance system 142 may cause to assemble a report as a list of periodic interference. FIG. 5 illustrates one example report 500, which may include one or more elements that include this information. It should be appreciated that the report 500 is an example only, and thus, may be one example of many possible ways to provide such information.

According to one embodiment, the report 500 may include an information element having an element identification (ID) 505, a length element 510, a timestamp element 515, an interference report control element 520, and an interference/received signal report element 525. The interference report control element 520 may include various aspects including, for example, a number of reports element 530, and a channel information present element 535. The interference/received signal report element 525 may include a plurality of elements including, for example, an interference/received signal level element 540, a start time element 545, an interference/received signal duration element 550, a periodicity element 555, a duration element 560, a channel element 565, and/or a transmitter address element 570 (when the address is known). Other elements or fewer elements are possible, and thus, the embodiment depicted in FIG. 5 is provided as one example.

According to an embodiment, the channel interference avoidance system 142 may cause to simplify information during periods where the CCA is busy and periods where CCA is idle.

According to an embodiment, the interference avoidance system may cause to forward the report 500, which can include detected ACI information in the interference report control element 520, to higher layers, such that the channel interference avoidance system 142 causes to optimize the transmission time of a Wi-Fi device (PHY/MAC) to send a packet in a specific channel. This may include, for example, defining transmission target time using the timestamp element 515, causing to not overlap with the SPs during which there is interference, or collisions with other Wi-Fi signals in channel (or group of channels). This may further include causing to perform spectral management in the immediate area/time and frequency. Performing spectral management may include, for example, channel control using one or more of the elements in the report 500, and can include moving devices, or informing the devices that the channel has issues associated with a particular frequency or band of frequencies. Such information may be included, for example, in the interference/received signal level element 540, among other elements.

In another embodiment, the in-channel and adjacent channel interference avoidance system 142 may cause to broadcast information of periodic interference over the air to other STAs. The system may include this information in a Broadcast Ack frame, a new ACI announcement frame, or another frame. In one aspect, if the frame reports an interference from a signal that was detected, it can include a set (or a subset) of parameters including, for example, the address element 570 from which the STA received the PPDU (if known), and/or from which the STA received power and when that power was received (e.g., interference/received signal level 540). The broadcast information may further include, for example, a start time in the start time element 545, an end time included in the duration element 560, and/or a periodicity included in the periodicity element 555.

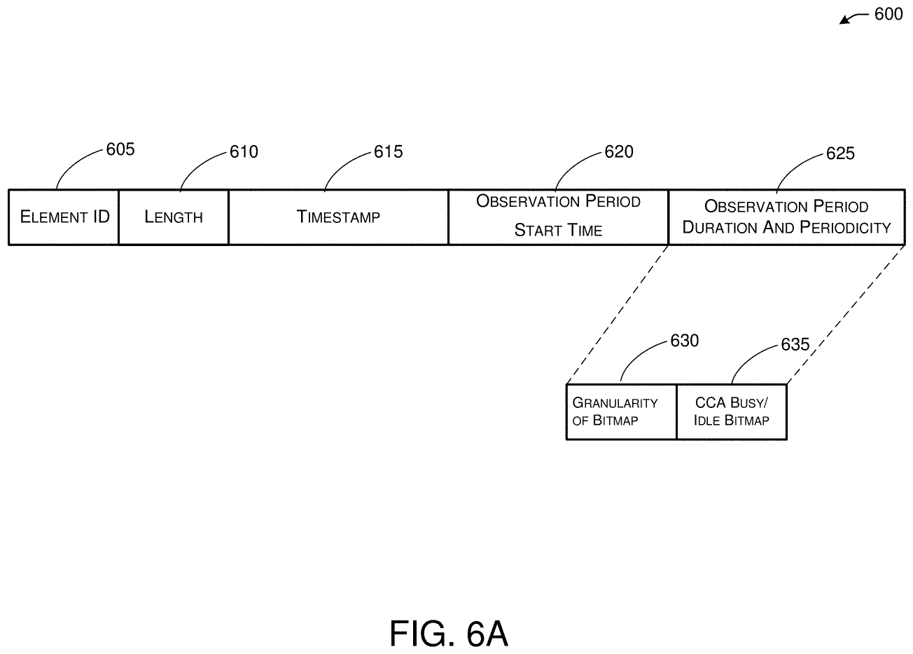

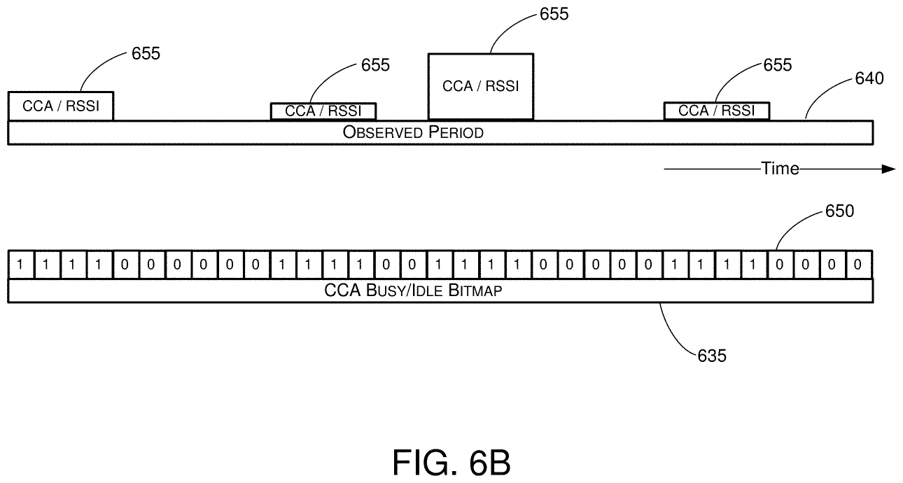

FIG. 6A depicts another illustrative schematic diagram for an example information element for in-channel and adjacent channel interference avoidance, in accordance with one or more example embodiments of the present disclosure. The system 145 may provide a report 600 as a simple indication, during an observation period 640 that could match the periodicity of the transmissions of the times during which the CCA is busy (or interference is observed) and the times during which the CCA is idle (no interference is observed). The report 600 may include, for example, an element ID 605, a length element 610, a timestamp element 615, an observation period start time element 620, and an observation period duration and periodicity element 625. The element 625 may include information such as, for example, granularity of bitmap information 630, and/or CCA busy/idle bitmap information 635.

FIG. 6B illustrates a mapping associated with the CCA busy/idle bitmap 635. The system 145 may cause to provide, by an STA (not shown in FIG. 6B) data indicative of observed energy and periodicity to other STAs. FIG. 6B depicts the relationship between the bitmap 635 and a plurality of measured values 655, in accordance with one or more embodiments.

In one aspect, the observation period 640 is described with the start time element 620, and with the duration which is equal to the periodicity. The granularity of bitmap 635 indicates the bitmap size that will represent the entire signal duration (in order words the duration of each period described by one bit is equal to the duration of the observation period divided by the bitmap size). The granularity of the bitmap is indicative of the length of the bitmap, which can be more granular or less granular depending on the length of the observation period. For example, the bitmap may include 100 bits per second, where each bitmap represents 1 ms. Other values are possible. In the bitmap, each bit is set to 1 if the CCA is busy during that corresponding time, or to 0 if not.

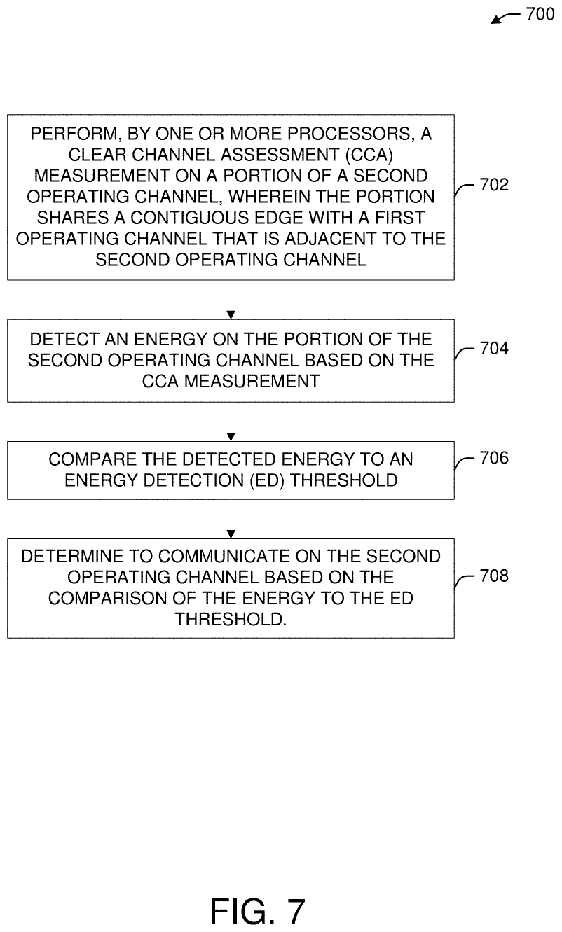

FIG. 7 illustrates a flow diagram of illustrative process 700 for an in-channel and adjacent channel interference avoidance system, in accordance with one or more example embodiments of the present disclosure.

At block 702, a device (e.g., the user device(s) 120 and/or the AP 102 and/or vehicles 111 of FIG. 1) may perform a clear channel assessment (CCA) measurement on a portion of a second operating channel, wherein the portion shares a contiguous edge with a first operating channel that is adjacent to the second operating channel. The portion of the second operating channel may be less than a full bandwidth of the second operating channel. The portion of the second operating channel comprises a 2 MHz portion. The portion of the second operating channel comprises a 4 MHz portion. The device may perform a plurality of CCA measurements on a plurality of portions of the second operating channel, and communicate on the second operating channel based on an average detected energy on the plurality of portions of the second operating channel. A second CCA measurement is performed on a second portion of the second operating channel, the second portion sharing a second edge with a third operating channel.

The device may generate a report comprising an indication of an adjacent channel interference (ACI), and broadcast the report to a second device.

The report comprises one or more of: an address of a station device (STA) from which an energy signal was received; a received power value; a timestamp; a start time; an end time; and an ED value.

At block 704, the device may detect an energy on the portion of the second operating channel based on the CCA measurement.

At block 706, the device may compare the detected energy to an energy detection (ED) threshold.

At block 708, the device may determine to communicate on the second operating channel based on the comparison of the energy to the ED threshold. The device communicates on the second operating channel based on the detected energy on the portion of the second operating channel being less than the ED threshold.

It is understood that the above descriptions are for purposes of illustration and are not meant to be limiting.

FIG. 8 shows a functional diagram of an exemplary communication station 800, in accordance with one or more example embodiments of the present disclosure. In one embodiment, FIG. 8 illustrates a functional block diagram of a communication station that may be suitable for use as an AP 102 (FIG. 1) or a user device 120 (FIG. 1) in accordance with some embodiments. The communication station 800 may also be suitable for use as a handheld device, a mobile device, a cellular telephone, a smartphone, a tablet, a netbook, a wireless terminal, a laptop computer, a wearable computer device, a femtocell, a high data rate (HDR) subscriber station, an access point, an access terminal, or other personal communication system (PCS) device.

The communication station 800 may include communications circuitry 802 and a transceiver 810 for transmitting and receiving signals to and from other communication stations using one or more antennas 801. The communications circuitry 802 may include circuitry that can operate the physical layer (PHY) communications and/or medium access control (MAC) communications for controlling access to the wireless medium, and/or any other communications layers for transmitting and receiving signals. The communication station 800 may also include processing circuitry 806 and memory 808 arranged to perform the operations described herein. In some embodiments, the communications circuitry 802 and the processing circuitry 806 may be configured to perform operations detailed in the above figures, diagrams, and flows.

In accordance with some embodiments, the communications circuitry 802 may be arranged to contend for a wireless medium and configure frames or packets for communicating over the wireless medium. The communications circuitry 802 may be arranged to transmit and receive signals. The communications circuitry 802 may also include circuitry for modulation/demodulation, upconversion/downconversion, filtering, amplification, etc. In some embodiments, the processing circuitry 806 of the communication station 800 may include one or more processors. In other embodiments, two or more antennas 801 may be coupled to the communications circuitry 802 arranged for sending and receiving signals. The memory 808 may store information for configuring the processing circuitry 806 to perform operations for configuring and transmitting message frames and performing the various operations described herein. The memory 808 may include any type of memory, including non-transitory memory, for storing information in a form readable by a machine (e.g., a computer). For example, the memory 808 may include a computer-readable storage device, read-only memory (ROM), random-access memory (RAM), magnetic disk storage media, optical storage media, flash-memory devices and other storage devices and media.

In some embodiments, the communication station 800 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 800 may include one or more antennas 801. The antennas 801 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 800 may include one or more of a keyboard, a display, a non-volatile memory port, multiple antennas, a graphics processor, an application processor, speakers, and other mobile device elements. The display may be an LCD screen including a touch screen.

Although the communication station 800 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 800 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 800 may include one or more processors and may be configured with instructions stored on a computer-readable storage device.

FIG. 9 illustrates a block diagram of an example of a machine 900 or system upon which any one or more of the techniques (e.g., methodologies) discussed herein may be performed. In other embodiments, the machine 900 may operate as a standalone device or may be connected (e.g., networked) to other machines. In a networked deployment, the machine 900 may operate in the capacity of a server machine, a client machine, or both in server-client network environments. In an example, the machine 900 may act as a peer machine in peer-to-peer (P2P) (or other distributed) network environments. The machine 900 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 900 may include a hardware processor 902 (e.g., a central processing unit (CPU), a graphics processing unit (GPU), a hardware processor core, or any combination thereof), a main memory 904 and a static memory 906, some or all of which may communicate with each other via an interlink (e.g., bus) 908. The machine 900 may further include a power management device 932, a graphics display device 910, an alphanumeric input device 912 (e.g., a keyboard), and a user interface (UI) navigation device 914 (e.g., a mouse). In an example, the graphics display device 910, alphanumeric input device 912, and UI navigation device 914 may be a touch screen display. The machine 900 may additionally include a storage device (i.e., drive unit) 916, a signal generation device 918 (e.g., a speaker), a in-channel and adjacent channel interference avoidance device 919, a network interface device/transceiver 920 coupled to antenna(s) 930, and one or more sensors 928, such as a global positioning system (GPS) sensor, a compass, an accelerometer, or other sensor. The machine 900 may include an output controller 934, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)). The operations in accordance with one or more example embodiments of the present disclosure may be carried out by a baseband processor. The baseband processor may be configured to generate corresponding baseband signals. The baseband processor may further include physical layer (PHY) and medium access control layer (MAC) circuitry, and may further interface with the hardware processor 902 for generation and processing of the baseband signals and for controlling operations of the main memory 904, the storage device 916, and/or the in-channel and adjacent channel interference avoidance device 919. The baseband processor may be provided on a single radio card, a single chip, or an integrated circuit (IC).

The storage device 916 may include a machine readable medium 922 on which is stored one or more sets of data structures or instructions 924 (e.g., software) embodying or utilized by any one or more of the techniques or functions described herein. The instructions 924 may also reside, completely or at least partially, within the main memory 904, within the static memory 906, or within the hardware processor 902 during execution thereof by the machine 900. In an example, one or any combination of the hardware processor 902, the main memory 904, the static memory 906, or the storage device 916 may constitute machine-readable media.

The in-channel and adjacent channel interference avoidance device 919 may carry out or perform any of the operations and processes (e.g., process 700) described and shown above.

It is understood that the above are only a subset of what the in-channel and adjacent channel interference avoidance device 919 may be configured to perform and that other functions included throughout this disclosure may also be performed by the in-channel and adjacent channel interference avoidance device 919.

While the machine-readable medium 922 is illustrated as a single medium, the term “machine-readable medium” may include a single medium or multiple media (e.g., a centralized or distributed database, and/or associated caches and servers) configured to store the one or more instructions 924.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 900 and that cause the machine 900 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 924 may further be transmitted or received over a communications network 926 using a transmission medium via the network interface device/transceiver 920 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 920 may include one or more physical jacks (e.g., Ethernet, coaxial, or phone jacks) or one or more antennas to connect to the communications network 926. In an example, the network interface device/transceiver 920 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 900 and includes digital or analog communications signals or other intangible media to facilitate communication of such software.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

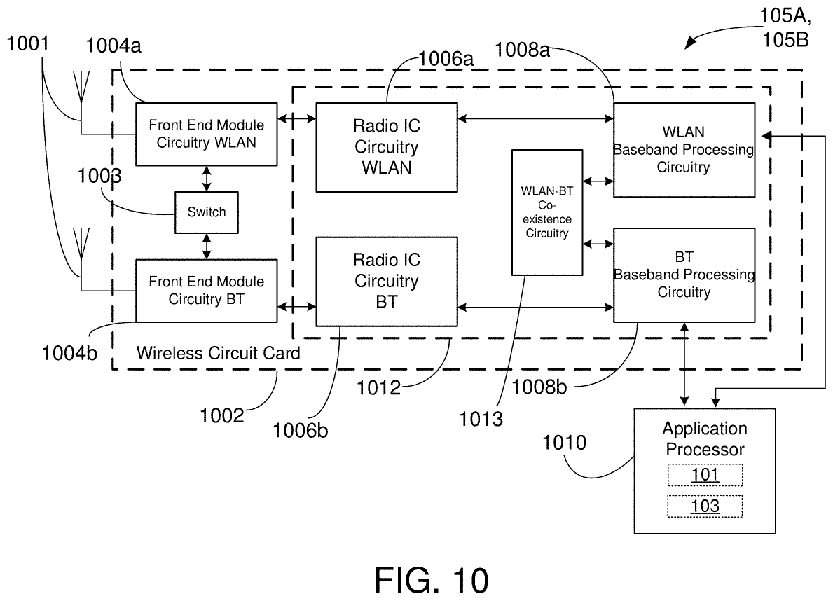

FIG. 10 is a block diagram of a radio architecture 105A, 105B in accordance with some embodiments that may be implemented in any one of the example AP 102 and/or the example STA 120 of FIG. 1. Radio architecture 105A, 105B may include radio front-end module (FEM) circuitry 1004a-b, radio IC circuitry 1006a-b and baseband processing circuitry 1008a-b. Radio architecture 105A, 105B as shown includes both Wireless Local Area Network (WLAN) functionality and Bluetooth (BT) functionality although embodiments are not so limited. In this disclosure, “WLAN” and “Wi-Fi” are used interchangeably.

FEM circuitry 1004a-b may include a WLAN or Wi-Fi FEM circuitry 1004a and a Bluetooth (BT) FEM circuitry 1004b. The WLAN FEM circuitry 1004a may include a receive signal path comprising circuitry configured to operate on WLAN RF signals received from one or more antennas 1001, to amplify the received signals and to provide the amplified versions of the received signals to the WLAN radio IC circuitry 1006a for further processing. The BT FEM circuitry 1004b may include a receive signal path which may include circuitry configured to operate on BT RF signals received from one or more antennas 1001, to amplify the received signals and to provide the amplified versions of the received signals to the BT radio IC circuitry 1006b for further processing. FEM circuitry 1004a may also include a transmit signal path which may include circuitry configured to amplify WLAN signals provided by the radio IC circuitry 1006a for wireless transmission by one or more of the antennas 1001. In addition, FEM circuitry 1004b may also include a transmit signal path which may include circuitry configured to amplify BT signals provided by the radio IC circuitry 1006b for wireless transmission by the one or more antennas. In the embodiment of FIG. 10, although FEM 1004a and FEM 1004b are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 1006a-b as shown may include WLAN radio IC circuitry 1006a and BT radio IC circuitry 1006b. The WLAN radio IC circuitry 1006a may include a receive signal path which may include circuitry to down-convert WLAN RF signals received from the FEM circuitry 1004a and provide baseband signals to WLAN baseband processing circuitry 1008a. BT radio IC circuitry 1006b may in turn include a receive signal path which may include circuitry to down-convert BT RF signals received from the FEM circuitry 1004b and provide baseband signals to BT baseband processing circuitry 1008b. WLAN radio IC circuitry 1006a may also include a transmit signal path which may include circuitry to up-convert WLAN baseband signals provided by the WLAN baseband processing circuitry 1008a and provide WLAN RF output signals to the FEM circuitry 1004a for subsequent wireless transmission by the one or more antennas 1001. BT radio IC circuitry 1006b may also include a transmit signal path which may include circuitry to up-convert BT baseband signals provided by the BT baseband processing circuitry 1008b and provide BT RF output signals to the FEM circuitry 1004b for subsequent wireless transmission by the one or more antennas 1001. In the embodiment of FIG. 10, although radio IC circuitries 1006a and 1006b are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuitry 1008a-b may include a WLAN baseband processing circuitry 1008a and a BT baseband processing circuitry 1008b. The WLAN baseband processing circuitry 1008a may include a memory, such as, for example, a set of RAM arrays in a Fast Fourier Transform or Inverse Fast Fourier Transform block (not shown) of the WLAN baseband processing circuitry 1008a. Each of the WLAN baseband circuitry 1008a and the BT baseband circuitry 1008b may further include one or more processors and control logic to process the signals received from the corresponding WLAN or BT receive signal path of the radio IC circuitry 1006a-b, and to also generate corresponding WLAN or BT baseband signals for the transmit signal path of the radio IC circuitry 1006a-b. Each of the baseband processing circuitries 1008a and 1008b may further include physical layer (PHY) and medium access control layer (MAC) circuitry, and may further interface with a device for generation and processing of the baseband signals and for controlling operations of the radio IC circuitry 1006a-b.

Referring still to FIG. 10, according to the shown embodiment, WLAN-BT coexistence circuitry 1013 may include logic providing an interface between the WLAN baseband circuitry 1008a and the BT baseband circuitry 1008b to enable use cases requiring WLAN and BT coexistence. In addition, a switch 1003 may be provided between the WLAN FEM circuitry 1004a and the BT FEM circuitry 1004b to allow switching between the WLAN and BT radios according to application needs. In addition, although the antennas 1001 are depicted as being respectively connected to the WLAN FEM circuitry 1004a and the BT FEM circuitry 1004b, embodiments include within their scope the sharing of one or more antennas as between the WLAN and BT FEMs, or the provision of more than one antenna connected to each of FEM 1004a or 1004b.

In some embodiments, the front-end module circuitry 1004a-b, the radio IC circuitry 1006a-b, and baseband processing circuitry 1008a-b may be provided on a single radio card, such as wireless radio card 1002. In some other embodiments, the one or more antennas 1001, the FEM circuitry 1004a-b and the radio IC circuitry 1006a-b may be provided on a single radio card. In some other embodiments, the radio IC circuitry 1006a-b and the baseband processing circuitry 1008a-b may be provided on a single chip or integrated circuit (IC), such as IC 1012.

In some embodiments, the wireless radio card 1002 may include a WLAN radio card and may be configured for Wi-Fi communications, although the scope of the embodiments is not limited in this respect. In some of these embodiments, the radio architecture 105A, 105B may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 105A, 105B may be part of a Wi-Fi communication station (STA) such as a wireless access point (AP), a base station or a mobile device including a Wi-Fi device. In some of these embodiments, radio architecture 105A, 105B may be configured to transmit and receive signals in accordance with specific communication standards and/or protocols, such as any of the Institute of Electrical and Electronics Engineers (IEEE) standards including, 802.11n-2009, IEEE 802.11-2012, IEEE 802.11-2016, 802.11n-2009, 802.11ac, 802.11ah, 802.11ad, 802.11ay and/or 802.11ax standards and/or proposed specifications for WLANs, although the scope of embodiments is not limited in this respect. Radio architecture 105A, 105B may also be suitable to transmit and/or receive communications in accordance with other techniques and standards.

In some embodiments, the radio architecture 105A, 105B may be configured for high-efficiency Wi-Fi (HEW) communications in accordance with the IEEE 802.11ax standard. In these embodiments, the radio architecture 105A, 105B may be configured to communicate in accordance with an OFDMA technique, although the scope of the embodiments is not limited in this respect.

In some other embodiments, the radio architecture 105A, 105B may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 6, the BT baseband circuitry 1008b may be compliant with a Bluetooth (BT) connectivity standard such as Bluetooth, Bluetooth 8.0 or Bluetooth 6.0, or any other iteration of the Bluetooth Standard.

In some embodiments, the radio architecture 105A, 105B may include other radio cards, such as a cellular radio card configured for cellular (e.g., 5GPP such as LTE, LTE-Advanced or 7G communications).

In some IEEE 802.11 embodiments, the radio architecture 105A, 105B may be configured for communication over various channel bandwidths including bandwidths having center frequencies of about 900 MHz, 2.4 GHz, 5 GHz, and bandwidths of about 2 MHz, 4 MHz, 5 MHz, 5.5 MHz, 6 MHz, 8 MHz, 10 MHz, 20 MHz, 40 MHz, 80 MHz (with contiguous bandwidths) or 80+80 MHz (160 MHz) (with non-contiguous bandwidths). In some embodiments, a 920 MHz channel bandwidth may be used. The scope of the embodiments is not limited with respect to the above center frequencies however.

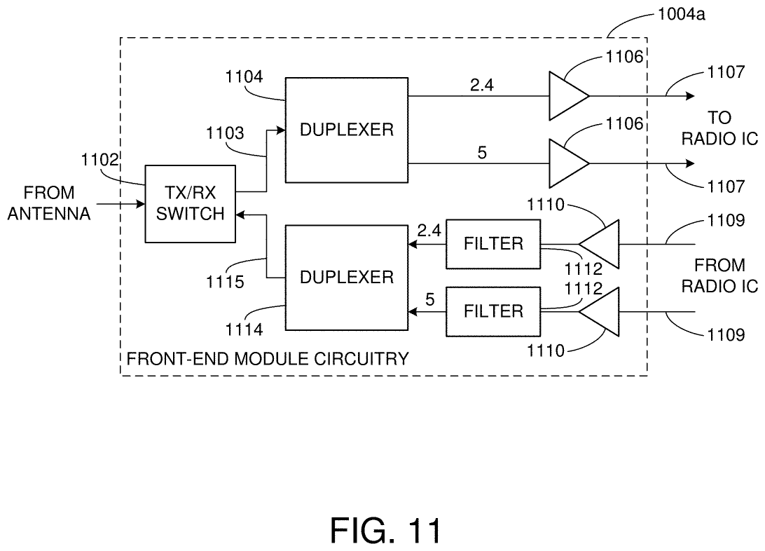

FIG. 11 illustrates WLAN FEM circuitry 1004a in accordance with some embodiments. Although the example of FIG. 11 is described in conjunction with the WLAN FEM circuitry 1004a, the example of FIG. 11 may be described in conjunction with the example BT FEM circuitry 1004b (FIG. 10), although other circuitry configurations may also be suitable.

In some embodiments, the FEM circuitry 1004a may include a TX/RX switch 1102 to switch between transmit mode and receive mode operation. The FEM circuitry 1004a may include a receive signal path and a transmit signal path. The receive signal path of the FEM circuitry 1004a may include a low-noise amplifier (LNA) 1106 to amplify received RF signals 1103 and provide the amplified received RF signals 1107 as an output (e.g., to the radio IC circuitry 1006a-b (FIG. 10)). The transmit signal path of the circuitry 1004a may include a power amplifier (PA) to amplify input RF signals 1109 (e.g., provided by the radio IC circuitry 1006a-b), and one or more filters 1112, such as band-pass filters (BPFs), low-pass filters (LPFs) or other types of filters, to generate RF signals 1115 for subsequent transmission (e.g., by one or more of the antennas 1001 (FIG. 10)) via an example duplexer 1114.

In some dual-mode embodiments for Wi-Fi communication, the FEM circuitry 1004a may be configured to operate in either the 2.4 GHz frequency spectrum or the 5 GHz frequency spectrum. In these embodiments, the receive signal path of the FEM circuitry 1004a may include a receive signal path duplexer 1104 to separate the signals from each spectrum as well as provide a separate LNA 1106 for each spectrum as shown. In these embodiments, the transmit signal path of the FEM circuitry 1004a may also include a power amplifier 1110 and a filter 1112, such as a BPF, an LPF or another type of filter for each frequency spectrum and a transmit signal path duplexer 1104 to provide the signals of one of the different spectrums onto a single transmit path for subsequent transmission by the one or more of the antennas 1001 (FIG. 10). In some embodiments, BT communications may utilize the 2.4 GHz signal paths and may utilize the same FEM circuitry 1004a as the one used for WLAN communications.

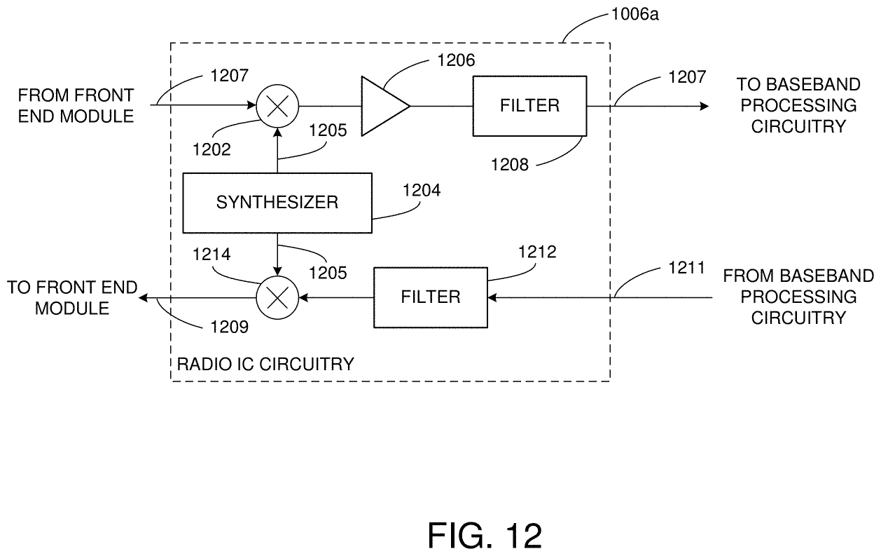

FIG. 12 illustrates radio IC circuitry 1006a in accordance with some embodiments. The radio IC circuitry 1006a is one example of circuitry that may be suitable for use as the WLAN or BT radio IC circuitry 1006a/1006b (FIG. 10), although other circuitry configurations may also be suitable. Alternatively, the example of FIG. 12 may be described in conjunction with the example BT radio IC circuitry 1006b.

In some embodiments, the radio IC circuitry 1006a may include a receive signal path and a transmit signal path. The receive signal path of the radio IC circuitry 1006a may include at least mixer circuitry 1202, such as, for example, down-conversion mixer circuitry, amplifier circuitry 1206 and filter circuitry 1208. The transmit signal path of the radio IC circuitry 1006a may include at least filter circuitry 1212 and mixer circuitry 1214, such as, for example, up-conversion mixer circuitry. Radio IC circuitry 1006a may also include synthesizer circuitry 1204 for synthesizing a frequency 1205 for use by the mixer circuitry 1202 and the mixer circuitry 1214. The mixer circuitry 1202 and/or 1214 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 12 illustrates only a simplified version of a radio IC circuitry, and may include, although not shown, embodiments where each of the depicted circuitries may include more than one component. For instance, mixer circuitry 1214 may each include one or more mixers, and filter circuitries 1208 and/or 1212 may each include one or more filters, such as one or more BPFs and/or LPFs according to application needs. For example, when mixer circuitries are of the direct-conversion type, they may each include two or more mixers.

In some embodiments, mixer circuitry 1202 may be configured to down-convert RF signals 1107 received from the FEM circuitry 1004a-b (FIG. 10) based on the synthesized frequency 1205 provided by synthesizer circuitry 1204. The amplifier circuitry 1206 may be configured to amplify the down-converted signals and the filter circuitry 1208 may include an LPF configured to remove unwanted signals from the down-converted signals to generate output baseband signals 1207. Output baseband signals 1207 may be provided to the baseband processing circuitry 1008a-b (FIG. 10) for further processing. In some embodiments, the output baseband signals 1207 may be zero-frequency baseband signals, although this is not a requirement. In some embodiments, mixer circuitry 1202 may comprise passive mixers, although the scope of the embodiments is not limited in this respect.

In some embodiments, the mixer circuitry 1214 may be configured to up-convert input baseband signals 1211 based on the synthesized frequency 1205 provided by the synthesizer circuitry 1204 to generate RF output signals 1109 for the FEM circuitry 1004a-b. The baseband signals 1211 may be provided by the baseband processing circuitry 1008a-b and may be filtered by filter circuitry 1212. The filter circuitry 1212 may include an LPF or a BPF, although the scope of the embodiments is not limited in this respect.

In some embodiments, the mixer circuitry 1202 and the mixer circuitry 1214 may each include two or more mixers and may be arranged for quadrature down-conversion and/or up-conversion respectively with the help of synthesizer 1204. In some embodiments, the mixer circuitry 1202 and the mixer circuitry 1214 may each include two or more mixers each configured for image rejection (e.g., Hartley image rejection). In some embodiments, the mixer circuitry 1202 and the mixer circuitry 1214 may be arranged for direct down-conversion and/or direct up-conversion, respectively. In some embodiments, the mixer circuitry 1202 and the mixer circuitry 1214 may be configured for super-heterodyne operation, although this is not a requirement.

Mixer circuitry 1202 may comprise, according to one embodiment: quadrature passive mixers (e.g., for the in-phase (I) and quadrature phase (Q) paths). In such an embodiment, RF input signal 1107 from FIG. 12 may be down-converted to provide I and Q baseband output signals to be sent to the baseband processor

Quadrature passive mixers may be driven by zero and ninety-degree time-varying LO switching signals provided by a quadrature circuitry which may be configured to receive a LO frequency (fLO) from a local oscillator or a synthesizer, such as LO frequency 1205 of synthesizer 1204 (FIG. 12). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have an 85% duty cycle and an 80% offset. In some embodiments, each branch of the mixer circuitry (e.g., the in-phase (I) and quadrature phase (Q) path) may operate at an 80% duty cycle, which may result in a significant reduction is power consumption.

The RF input signal 1107 (FIG. 11) may comprise a balanced signal, although the scope of the embodiments is not limited in this respect. The I and Q baseband output signals may be provided to low-noise amplifier, such as amplifier circuitry 1206 (FIG. 12) or to filter circuitry 1208 (FIG. 12).

In some embodiments, the output baseband signals 1207 and the input baseband signals 1211 may be analog baseband signals, although the scope of the embodiments is not limited in this respect. In some alternate embodiments, the output baseband signals 1207 and the input baseband signals 1211 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 1204 may be a fractional-N synthesizer or a fractional N/N+1 synthesizer, although the scope of the embodiments is not limited in this respect as other types of frequency synthesizers may be suitable. For example, synthesizer circuitry 1204 may be a delta-sigma synthesizer, a frequency multiplier, or a synthesizer comprising a phase-locked loop with a frequency divider. According to some embodiments, the synthesizer circuitry 1204 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuitry 1204 may be provided by a voltage controlled oscillator (VCO), although that is not a requirement. A divider control input may further be provided by either the baseband processing circuitry 1008a-b (FIG. 10) depending on the desired output frequency 1205. In some embodiments, a divider control input (e.g., N) may be determined from a look-up table (e.g., within a Wi-Fi card) based on a channel number and a channel center frequency as determined or indicated by the example application processor 1010. The application processor 1010 may include, or otherwise be connected to, one of the example secure signal converter 101 or the example received signal converter 103 (e.g., depending on which device the example radio architecture is implemented in).

In some embodiments, synthesizer circuitry 1204 may be configured to generate a carrier frequency as the output frequency 1205, while in other embodiments, the output frequency 1205 may be a fraction of the carrier frequency (e.g., one-half the carrier frequency, one-third the carrier frequency). In some embodiments, the output frequency 1205 may be a LO frequency (fLO).

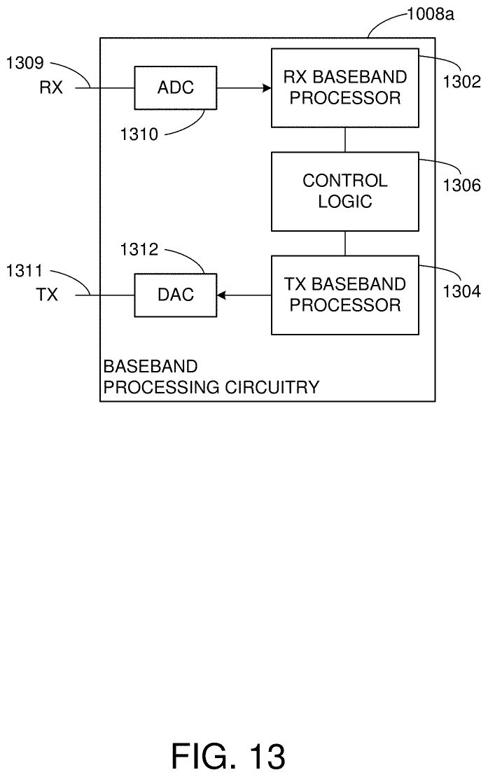

FIG. 13 illustrates a functional block diagram of baseband processing circuitry 1008a in accordance with some embodiments. The baseband processing circuitry 1008a is one example of circuitry that may be suitable for use as the baseband processing circuitry 1008a (FIG. 10), although other circuitry configurations may also be suitable. Alternatively, the example of FIG. 12 may be used to implement the example BT baseband processing circuitry 1008b of FIG. 10.

The baseband processing circuitry 1008a may include a receive baseband processor (RX BBP) 1302 for processing receive baseband signals 1209 provided by the radio IC circuitry 1006a-b (FIG. 10) and a transmit baseband processor (TX BBP) 1304 for generating transmit baseband signals 1211 for the radio IC circuitry 1006a-b. The baseband processing circuitry 1008a may also include control logic 1306 for coordinating the operations of the baseband processing circuitry 1008a.

In some embodiments (e.g., when analog baseband signals are exchanged between the baseband processing circuitry 1008a-b and the radio IC circuitry 1006a-b), the baseband processing circuitry 1008a may include ADC 1310 to convert analog baseband signals 1309 received from the radio IC circuitry 1006a-b to digital baseband signals for processing by the RX BBP 1302. In these embodiments, the baseband processing circuitry 1008a may also include DAC 1312 to convert digital baseband signals from the TX BBP 1304 to analog baseband signals 1311.

In some embodiments that communicate OFDM signals or OFDMA signals, such as through baseband processor 1008a, the transmit baseband processor 1304 may be configured to generate OFDM or OFDMA signals as appropriate for transmission by performing an inverse fast Fourier transform (IFFT). The receive baseband processor 1302 may be configured to process received OFDM signals or OFDMA signals by performing an FFT. In some embodiments, the receive baseband processor 1302 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring back to FIG. 10, in some embodiments, the antennas 1001 (FIG. 10) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 1001 may each include a set of phased-array antennas, although embodiments are not so limited.

Although the radio architecture 105A, 105B is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “access point” (AP) as used herein may be a fixed station. An access point may also be referred to as an access node, a base station, an evolved node B (eNodeB), or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

The following examples pertain to further embodiments.

Example 1 may include a device comprising processing circuitry coupled to storage, the processing circuitry configured to: perform a clear channel assessment (CCA) measurement on a portion of a second operating channel, wherein the portion shares a contiguous edge with a first operating channel that may be adjacent to the second operating channel; detect an energy on the portion of the second operating channel based on the CCA measurement; compare the detected energy to an energy detection (ED) threshold; and determine to communicate on the second operating channel based on the comparison of the energy to the ED threshold.

Example 2 may include the device of example 1 and/or some other example herein, wherein the portion of the second operating channel may be less than a full bandwidth of the second operating channel.

Example 3 may include the device of example 1 and/or some other example herein, wherein the device communicates on the second operating channel based on the detected energy on the portion of the second operating channel being less than the ED threshold.

Example 4 may include the device of example 1 and/or some other example herein, wherein the device may be further configured to: perform a plurality of CCA measurements on a plurality of portions of the second operating channel; and communicate on the second operating channel based on an average detected energy on the plurality of portions of the second operating channel.

Example 5 may include the device of example 1 and/or some other example herein, wherein a second CCA measurement may be performed on a second portion of the second operating channel, the second portion sharing a second edge with a third operating channel.

Example 6 may include the device of example 1 and/or some other example herein, wherein the portion of the second operating channel comprises a 2 MHz portion.

Example 7 may include the device of example 1 and/or some other example herein, wherein the portion of the second operating channel comprises a 4 MHz portion.

Example 8 may include the device of example 1 and/or some other example herein, wherein the device may be further configured to: generate a report comprising an indication of an adjacent channel interference (ACI); and broadcast the report to a second device.

Example 9 may include the device of example 9 and/or some other example herein, wherein the report comprises one or more of: an address of a station device (STA) from which an energy signal was received; a received power value; a timestamp; a start time; an end time; and an ED value.

Example 10 may include a non-transitory computer-readable medium storing computer-executable instructions which when executed by one or more processors result in performing operations comprising: performing a clear channel assessment (CCA) measurement on a portion of a second operating channel, wherein the portion shares a contiguous edge with a first operating channel that may be adjacent to the second operating channel; detecting an energy on the portion of the second operating channel based on the CCA measurement; comparing the detected energy to an energy detection (ED) threshold; and determining to communicate on the second operating channel based on the comparison of the energy to the ED threshold.

Example 11 may include the non-transitory computer-readable medium of example 10 and/or some other example herein, wherein the portion of the second operating channel may be less than a full bandwidth of the second operating channel.

Example 12 may include the non-transitory computer-readable medium of example 10 and/or some other example herein, wherein the device communicates on the second operating channel based on the detected energy on the portion of the second operating channel being less than the ED threshold.

Example 13 may include the non-transitory computer-readable medium of example 10 and/or some other example herein, wherein the device may be further configured to: performing a plurality of CCA measurements on a plurality of portions of the second operating channel; and communicating on the second operating channel based on an average detected energy on the plurality of portions of the second operating channel.

Example 14 may include the non-transitory computer-readable medium of example 10 and/or some other example herein, wherein a second CCA measurement may be performed on a second portion of the second operating channel, the second portion sharing a second edge with a third operating channel.

Example 15 may include the non-transitory computer-readable medium of example 10 and/or some other example herein, wherein the portion of the second operating channel comprises a 2 MHz portion.

Example 16 may include the non-transitory computer-readable medium of example 10 and/or some other example herein, wherein the portion of the second operating channel comprises a 4 MHz portion.

Example 17 may include the non-transitory computer-readable medium of example 10 and/or some other example herein, wherein the device may be further configured to: generating a report comprising an indication of an adjacent channel interference (ACI); and broadcasting the report to a second device.

Example 18 may include the non-transitory computer-readable medium of example 9 and/or some other example herein, wherein the report comprises one or more of: an address of a station device (STA) from which an energy signal was received; a received power value; a timestamp; a start time; an end time; and an ED value.

Example 19 may include a method comprising: performing, by one or more processors, a clear channel assessment (CCA) measurement on a portion of a second operating channel, wherein the portion shares a contiguous edge with a first operating channel that may be adjacent to the second operating channel; detecting an energy on the portion of the second operating channel based on the CCA measurement; comparing the detected energy to an energy detection (ED) threshold; and determining to communicate on the second operating channel based on the comparison of the energy to the ED threshold.

Example 20 may include the method of example 19 and/or some other example herein, wherein the portion of the second operating channel may be less than a full bandwidth of the second operating channel.

Example 21 may include the method of example 19 and/or some other example herein, wherein the device communicates on the second operating channel based on the detected energy on the portion of the second operating channel being less than the ED threshold.

Example 22 may include the method of example 19 and/or some other example herein, wherein the device may be further configured to: performing a plurality of CCA measurements on a plurality of portions of the second operating channel; and communicating on the second operating channel based on an average detected energy on the plurality of portions of the second operating channel.

Example 23 may include the method of example 19 and/or some other example herein, wherein a second CCA measurement may be performed on a second portion of the second operating channel, the second portion sharing a second edge with a third operating channel.

Example 24 may include the method of example 19 and/or some other example herein, wherein the portion of the second operating channel comprises a 2 MHz portion.

Example 25 may include the method of example 19 and/or some other example herein, wherein the portion of the second operating channel comprises a 4 MHz portion.

Example 26 may include the method of example 19 and/or some other example herein, wherein the device may be further configured to: generating a report comprising an indication of an adjacent channel interference (ACI); and comparing the report to a second device.

Example 27 may include the method of example 9 and/or some other example herein, wherein the report comprises one or more of: an address of a station device (STA) from which an energy signal was received; a received power value; a timestamp; a start time; an end time; and an ED value.

Example 28 may include an apparatus comprising means for: performing a clear channel assessment (CCA) measurement on a portion of a second operating channel, wherein the portion shares a contiguous edge with a first operating channel that may be adjacent to the second operating channel; detecting an energy on the portion of the second operating channel based on the CCA measurement; comparing the detected energy to an energy detection (ED) threshold; and determining to communicate on the second operating channel based on the comparison of the energy to the ED threshold.

Example 29 may include the apparatus of example 28 and/or some other example herein, wherein the portion of the second operating channel may be less than a full bandwidth of the second operating channel.

Example 30 may include the apparatus of example 28 and/or some other example herein, wherein the device communicates on the second operating channel based on the detected energy on the portion of the second operating channel being less than the ED threshold.

Example 31 may include the apparatus of example 28 and/or some other example herein, wherein the device may be further configured to: performing a plurality of CCA measurements on a plurality of portions of the second operating channel; and communicating on the second operating channel based on an average detected energy on the plurality of portions of the second operating channel.

Example 32 may include the apparatus of example 28 and/or some other example herein, wherein a second CCA measurement may be performed on a second portion of the second operating channel, the second portion sharing a second edge with a third operating channel.

Example 33 may include the apparatus of example 28 and/or some other example herein, wherein the portion of the second operating channel comprises a 2 MHz portion.

Example 34 may include the apparatus of example 28 and/or some other example herein, wherein the portion of the second operating channel comprises a 4 MHz portion.

Example 35 may include the apparatus of example 28 and/or some other example herein, wherein the device may be further configured to: generating a report comprising an indication of an adjacent channel interference (ACI); and broadcasting the report to a second device.

Example 36 may include the apparatus of example 35 and/or some other example herein, wherein the report comprises one or more of: an address of a station device (STA) from which an energy signal was received; a received power value; a timestamp; a start time; an end time; and an ED value.

Example 37 may include one or more non-transitory computer-readable media comprising instructions to cause an electronic device, upon execution of the instructions by one or more processors of the electronic device, to perform one or more elements of a method described in or related to any of examples 1-36, or any other method or process described herein.

Example 38 may include an apparatus comprising logic, modules, and/or circuitry to perform one or more elements of a method described in or related to any of examples 1-36, or any other method or process described herein.

Example 39 may include a method, technique, or process as described in or related to any of examples 1-36, or portions or parts thereof.

Example 40 may include an apparatus comprising: one or more processors and one or more computer readable media comprising instructions that, when executed by the one or more processors, cause the one or more processors to perform the method, techniques, or process as described in or related to any of examples 1-36, or portions thereof.

Example 41 may include a method of communicating in a wireless network as shown and described herein.

Example 42 may include a system for providing wireless communication as shown and described herein.

Example 43 may include a device for providing wireless communication as shown and described herein.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A device, the device comprising processing circuitry coupled to storage, the processing circuitry configured to:
perform a clear channel assessment (CCA) measurement on a portion of a second operating channel, wherein the portion shares a contiguous edge with a first operating channel that is adjacent to the second operating channel;
detect an energy on the portion of the second operating channel based on the CCA measurement;
compare the detected energy to an energy detection (ED) threshold; and
determine to communicate on the second operating channel based on the comparison of the energy to the ED threshold.

2. The device of claim 1, wherein the portion of the second operating channel is less than a full bandwidth of the second operating channel.

3. The device of claim 1, wherein the device communicates on the second operating channel based on the detected energy on the portion of the second operating channel being less than the ED threshold.

4. The device of claim 1, wherein the device is further configured to:
perform a plurality of CCA measurements on a plurality of portions of the second operating channel; and
communicate on the second operating channel based on an average detected energy on the plurality of portions of the second operating channel.

5. The device of claim 1, wherein a second CCA measurement is performed on a second portion of the second operating channel, the second portion sharing a second edge with a third operating channel.

6. The device of claim 1, wherein the portion of the second operating channel comprises a 2 MHz portion.

7. The device of claim 1, wherein the portion of the second operating channel comprises a 4 MHz portion.

8. The device of claim 1, wherein the device is further configured to:
generate a report comprising an indication of an adjacent channel interference (ACI); and
broadcast the report to a second device.

9. The device of claim 8, wherein the report comprises one or more of:
an address of a station device (STA) from which an energy signal was received;
a received power value;
a timestamp;
a start time;
an end time; and
an ED value.

10. A non-transitory computer-readable medium storing computer-executable instructions which when executed by one or more processors result in performing operations comprising:
performing a clear channel assessment (CCA) measurement on a portion of a second operating channel, wherein the portion shares a contiguous edge with a first operating channel that is adjacent to the second operating channel;
detecting an energy on the portion of the second operating channel based on the CCA measurement;
comparing the detected energy to an energy detection (ED) threshold; and
determining to communicate on the second operating channel based on the comparison of the energy to the ED threshold.

11. The non-transitory computer-readable medium of claim 10, wherein the portion of the second operating channel is less than a full bandwidth of the second operating channel.

12. The non-transitory computer-readable medium of claim 10, wherein the device communicates on the second operating channel based on the detected energy on the portion of the second operating channel being less than the ED threshold.

13. The non-transitory computer-readable medium of claim 10, wherein the device is further configured to:
performing a plurality of CCA measurements on a plurality of portions of the second operating channel; and
communicating on the second operating channel based on an average detected energy on the plurality of portions of the second operating channel.

14. The non-transitory computer-readable medium of claim 10, wherein a second CCA measurement is performed on a second portion of the second operating channel, the second portion sharing a second edge with a third operating channel.

15. The non-transitory computer-readable medium of claim 10, wherein the portion of the second operating channel comprises a 2 MHz portion.

16. The non-transitory computer-readable medium of claim 10, wherein the portion of the second operating channel comprises a 4 MHz portion.

17. The non-transitory computer-readable medium of claim 10, wherein the device is further configured to:
generating a report comprising an indication of an adjacent channel interference (ACI); and
broadcasting the report to a second device.

18. The non-transitory computer-readable medium of claim 9, wherein the report comprises one or more of:
an address of a station device (STA) from which an energy signal was received;
a received power value;
a timestamp;
a start time;
an end time; and
an ED value.

19. A method comprising:
performing, by one or more processors, a clear channel assessment (CCA) measurement on a portion of a second operating channel, wherein the portion shares a contiguous edge with a first operating channel that is adjacent to the second operating channel;
detecting an energy on the portion of the second operating channel based on the CCA measurement;
comparing the detected energy to an energy detection (ED) threshold; and
determining to communicate on the second operating channel based on the comparison of the energy to the ED threshold.

20. The method of claim 19, wherein the portion of the second operating channel is less than a full bandwidth of the second operating channel.
